(19) United States
(12) Patent Application Publication
(10) Pub. No.: US 2002/0052787 A1
(43) Pub. Date: May 2, 2002

(54) Method for providing advertisement contents

(76) Inventors: Kiyotaka Matsumoto, Saitama (JP); Atsushi Akamatsu, Fujisawa (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/924,524

(22) Filed: Aug. 9, 2001

(30) Foreign Application Priority Data
Oct. 31, 2000 (JP) 2000-332388

(51) Int. Cl. G06F 17/60

(52) U.S. Cl. 705/14

(57) ABSTRACT

From the facsimile apparatus of an advertiser, facsimile registration information indicating registrant ID, category ID, and advertisement contents is received. Image data of the advertisement contents are into advertiser-dedicated page data corresponding to registrant ID and category ID. From a subscriber-side processing apparatus to an advertisement service/management processing apparatus, a sending request for the advertisement contents stored in the advertiser-dedicated page data is sent. The requested advertisement contents are read from the advertiser-dedicated page data. The advertisement contents are sent to the subscriber-side processing apparatus which is a request source. When the sent advertisement contents are received, the advertisement contents are outputted to an output device of the subscriber-side processing apparatus.

### BACKGROUND OF THE INVENTION

The present invention relates to a system for displaying advertisement contents on an information processing apparatus connected to a network. In particular, it relates to a method effective when applied to the advertisement contents providing system for displaying advertisement contents requested through a facsimile apparatus by registering image data indicating the advertisement contents onto a home page on the information processing apparatus connected to the Internet.

Conventionally, when advertising information characteristic of a local area, e.g., special bargain information at a supermarket, event information, and employment information, an inserted leaflet with a newspaper delivered around the local area has been utilized so often. When advertising the information characteristic of the local area by using the inserted leaflet with the newspaper, the advertisement contents have been determined in advance to create the leaflet. Then, the leaflet is delivered with the newspaper.

Also, in recent years, with the development of the Internet, issuance of various types of information has been executed using the Internet. In the information issuance using the Internet, a contract is made with a provider so as to set up a home page, and various types of HTML (Hyper Text Markup Language) files or image files for performing the information issuance are stored beforehand onto a directory of the home page. Next, receiving an access request from a browser or the like, contents of the files are displayed on an information processing apparatus at an access-requesting source. This has allowed information issuance directed over the world.

Incidentally, JP-A-2000-194636 has disclosed an information providing method and a program recording medium on the Internet which enhance a banner click rate by site visitors in a banner advertisement-attached information providing system utilized via the Internet. Its general outline is to create an information providing method that will not provide service or information unless the banner is clicked, but that can provide a program easily convertible from a conventional WWW server.

In the above-described advertisement of the information characteristic of a local area by using the conventional inserted leaflet with the newspaper, it is required to create the inserted leaflet in advance and to have the leaflet delivered together with the newspaper. This condition results in a problem that it is impossible to immediately inform a consumer of information that has been determined on the very same day, e.g., the execution of a time service depending on a selling situation at a supermarket on the day.

Also, in the above-described information issuance using the Internet, it is always possible to modify contents of information by updating the contents of a home page. In order to update the contents of a home page, however, a user who is accustomed to operating an information processing apparatus needs to modify the contents, for example, by creating image data using a scanner or the like based on HTML programming. This condition results in a problem that advertiser of a small supermarket or the like who is not skilled at how to use the computer finds it difficult to execute the information issuance using the Internet.

### SUMMARY OF THE INVENTION

It is an object of the present invention to solve the above-described problems and to provide a method or a system that allows information to be delivered easily and immediately on an information processing apparatus connected to a network, without intervention of complicated operation of the information processing apparatus.

The present invention relates to an advertisement contents providing system for displaying, on the information processing apparatus connected to the network, advertisement contents registration of which has been requested from a facsimile apparatus, wherein the advertisement contents sent from the facsimile apparatus of an advertiser is stored into advertiser-dedicated page data and is outputted to an output device of a subscriber-side processing apparatus.

In the advertisement contents providing system of the present invention, when trying to issue information such as execution of a time service, facsimile registration information that indicates a registrant ID for identifying the advertiser, a category ID for indicating a category of the advertisement, and advertisement contents for indicating the contents of the information is sent from the facsimile apparatus of the advertiser to an advertisement service/management processing apparatus.

The advertisement service/management processing apparatus receives, from the facsimile apparatus of the advertiser, the facsimile registration information indicating the registrant ID, the category ID, and the advertisement contents. Then, after authenticating the registrant ID, the advertisement service/management processing apparatus stores image data of the advertisement contents into, of advertiser-dedicated page data stored in the advertisement service/management processing apparatus, advertiser-dedicated page data existing within a directory corresponding to the registrant ID and the category ID.

Meanwhile, the subscriber-side processing apparatus on the side of the subscriber who views the advertisement contents stored into the advertiser-dedicated page data as described above sends, from the subscriber-side processing apparatus to the advertisement service/management processing apparatus, a sending request for the advertisement contents stored in the advertiser-dedicated page data in the advertisement service/management processing apparatus.

Having received the sending request for the advertisement contents from the subscriber-side processing apparatus, the advertisement service/management processing apparatus reads from the advertiser-dedicated page data the advertisement contents requested from the subscriber-side processing apparatus, then sending the advertisement contents to the subscriber-side processing apparatus of the request source.

The subscriber-side processing apparatus receives the advertisement contents sent from the advertisement service/management processing apparatus so as to display the advertisement contents onto the output device of the subscriber-side processing apparatus, thereby presenting the advertisement contents to the subscriber.

As having been described above, according to the advertisement contents providing system of the present invention, the advertisement contents sent from the facsimile apparatus of the advertiser is stored into the advertiser-dedicated page data, then being outputted to the output device of the subscriber-side processing apparatus. This condition permits information to be delivered immediately on the information processing apparatus connected to the network, without intervention of complicated operation of the information processing apparatus.

### BRIEF DESCRIPTION OF THE DRAWINGS

FIG. 1 is a diagram for illustrating the schematic configuration of an advertisement contents providing system in the present embodiment;

FIG. 2 is a diagram for illustrating the schematic configuration of an advertisement service/management processing apparatus 100 in the present embodiment;

FIG. 3 is a diagram for illustrating the schematic configuration of a subscriber-side processing apparatus 101 in the present embodiment;

FIG. 4 is a diagram for illustrating the schematic configuration of a sales-office-side processing apparatus 102 in the present embodiment;

FIG. 5 is a flowchart for illustrating the processing steps of an advertisement registration processing in the present embodiment;

FIG. 6 is a diagram for illustrating one example of the advertisement contents in the present embodiment;

FIG. 7 is a flowchart for illustrating the processing steps of an advertisement contents display processing in the present embodiment;

FIG. 8 is a diagram for illustrating one example of a menu display in the present embodiment;

FIG. 9 is a flowchart for illustrating the processing steps of an advertisement contents sending processing in the present embodiment;

FIG. 10 is a flowchart for illustrating the processing steps of a collection target information inquiry processing in the present embodiment;

FIG. 11 is a flowchart for illustrating the processing steps of a collection target information sending processing in the present embodiment;

FIG. 12 is a flowchart for illustrating the processing steps of a collected information sending processing in the present embodiment; and

FIG. 13 is a flowchart for illustrating the processing steps of a collected information output processing in the present embodiment.

### DETAILED DESCRIPTION OF THE EMBODIMENTS

Hereinafter, explanation will be given concerning an advertisement contents providing system in one embodiment. In the present embodiment, advertisement contents requested for registration from a facsimile apparatus is stored onto a home page set up by a newspaper sales-office, thereby providing advertisement contents to a subscriber who subscribes the newspaper sales-office.

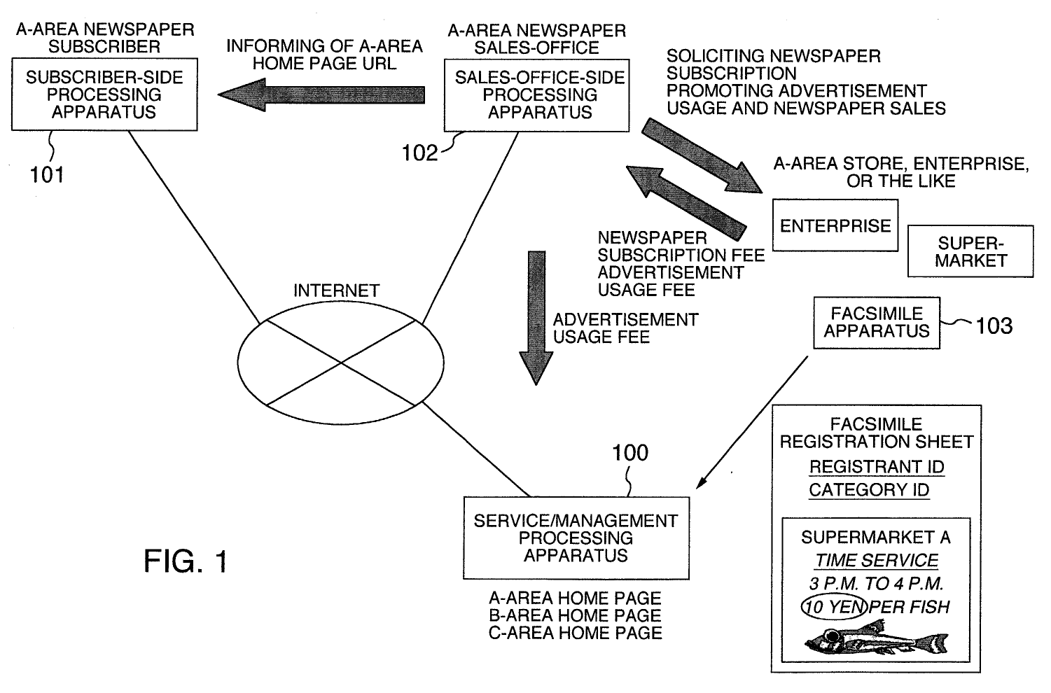

FIG. 1 is a diagram for illustrating the schematic configuration of the advertisement contents providing system in the present embodiment.

As illustrated in FIG. 1, the advertisement contents providing system in the present embodiment includes an advertisement service/management processing apparatus 100, a subscriber-side processing apparatus 101, a sales-office-side processing apparatus 102, and a facsimile apparatus 103.

The advertisement service/management processing apparatus 100 stores advertisement contents, requested for registration from the facsimile apparatus 103 of an advertiser, into advertiser-dedicated page data within a home page set up by a newspaper sales-office, sends the advertisement contents to the subscriber-side processing apparatus 101 on the side of a subscriber who subscribes the newspaper sales-office, and provides, on a network, the advertisement contents requested by the advertiser.

The subscriber-side processing apparatus 101 demands sending of the advertisement contents stored in the advertiser-dedicated page data in the advertisement service/management processing apparatus 100, receives the advertisement contents from the advertisement service/management processing apparatus 100, and outputs the advertisement contents.

The sales-office-side processing apparatus 102 makes an inquiry of the advertisement service/management processing apparatus 100 about collection target information indicating the advertiser that becomes the collection target of advertisement usage fee, and receives and outputs the collection target information. The facsimile apparatus 103 sends the advertisement service/management processing apparatus 100 facsimile registration information indicating a registrant ID for identifying the advertiser, a category ID for indicating the category of the advertisement, and the advertisement contents for indicating the contents of the information.

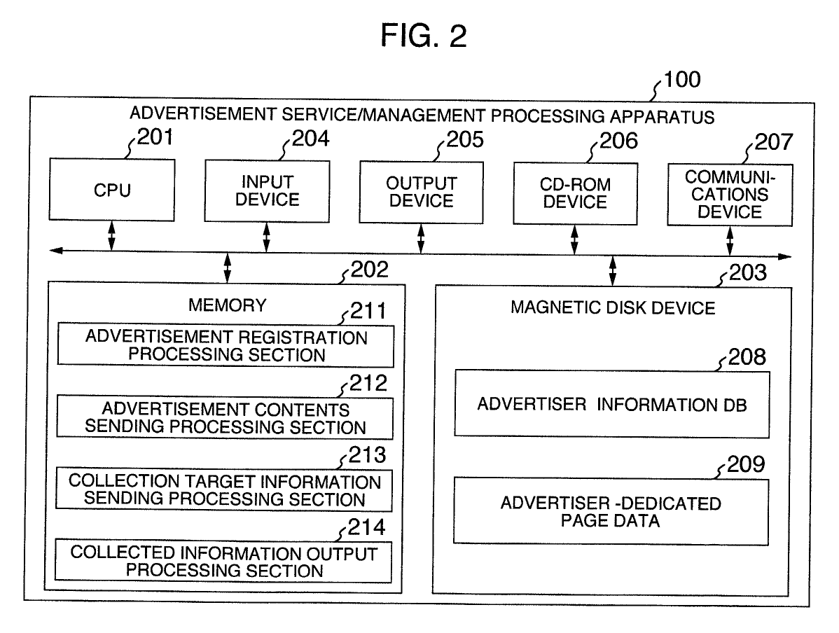

FIG. 2 is a diagram for illustrating the schematic configuration of the advertisement service/management processing apparatus 100 in the present embodiment. As illustrated in FIG. 2, the advertisement service/management processing apparatus 100 in the present embodiment includes a CPU 201, a memory 202, a magnetic disk device 203, an input device 204, an output device 205, a CD-ROM device 206, a communications device 207, an advertiser information database 208, and advertiser-dedicated page data 209.

CPU 201 controls the operation of the entire advertisement service/management processing apparatus 100. The memory 202 loads various types of processing programs or data for the control, when CPU 201 controls the operation of the entire advertisement service/management processing apparatus 100.

The magnetic disk device 203 stores various types of programs or data. The input device 204 performs various types of inputs for displaying the advertisement contents on the network. The output device 205 performs various types of outputs accompanied with display of the advertisement contents on the network.

The CD-ROM device 206 reads contents of a CD-ROM recording the various types of processing programs. The communications device 207 executes communications with other processing apparatuses via network such as the Internet or an intranet, and receives facsimile registration information sent from the facsimile apparatus 103 of the advertiser.

The advertiser information database 208 stores advertiser information indicating such information as the registrant IDs of advertisers who have made the contract to perform the advertisement publication on the advertiser-dedicated page in the advertisement service/management processing apparatus 100. The advertiser-dedicated page data 209 is image data or character data in the image data, which indicates the advertisement contents sent from the facsimile apparatus 103 of the advertiser.

Also, the advertisement service/management processing apparatus 100 includes an advertisement registration processing section or program 211, an advertisement contents sending processing section or program 212, a collection target information sending processing section or program 213, and a collected information output processing section or program 214.

The advertisement registration processing section 211 receives, from the facsimile apparatus 103 of the advertiser, facsimile registration information indicating the registrant ID for identifying the advertiser, the category ID for indicating the category to which the advertisement belong, and the advertisement contents, and stores the image data of the advertisement contents or the character data in the image data into the advertiser-dedicated page data 209 corresponding to the registrant ID and the category ID described in the facsimile registration information.

The advertisement contents sending processing section 212 reads from the advertiser-dedicated page data 209 the advertisement contents requested from the subscriber-side processing apparatus 101, and sends the advertisement contents to the subscriber-side processing apparatus 101 of the request source.

The collection target information sending processing section 213 receives, from the sales-office-side processing apparatus 102 set in the sales-office, the inquiry about the collection target information indicating the advertiser that becomes the collection target of the advertisement usage fee, makes reference to the advertiser information in the advertiser information database 208, reads, of the advertisers indicated by the advertiser information, information on an advertiser that is in charge of the sales-office that has made the above-described inquiry, and sends, to the sales-office-side processing apparatus 102, the information on the read advertiser as the collection target information indicating the advertiser to which the sales-office will make the collection of the advertisement usage fee.

The collected information output processing section 214 receives, from the sales-office-side processing apparatus 102, collected information indicating the advertiser to which the collection of the advertisement usage fee has been made, and outputs the collected information to the output device 205 of the advertisement service/management processing apparatus 100.

A program for causing the advertisement service/management processing apparatus 100 to function as the advertisement registration processing section 211, the advertisement contents sending processing section 212, the collection target information sending processing section 213, and the collected information output processing section 214 is recorded into a recording medium such as a CD-ROM and is stored into the magnetic disk or the like. After that, the above-described program is loaded onto the memory, then being executed. Incidentally, the recording medium for recording the program may be another recording medium other than the CD-ROM.

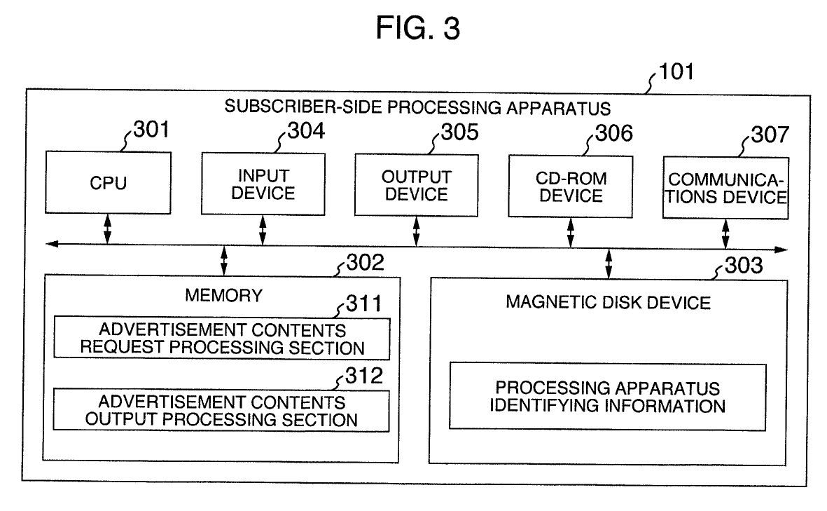

FIG. 3 is a diagram for illustrating the schematic configuration of the subscriber-side processing apparatus 101 in the present embodiment. As illustrated in FIG. 3, the subscriber-side processing apparatus 101 includes a CPU 301, a memory 302, a magnetic disk device 303, an input device 304, an output device 305, a CD-ROM device 306, and a communications device 307.

CPU 301 controls the operation of the entire subscriber-side processing apparatus 101. Memory 302 loads various types of processing programs or data for control, when controlling the operation of the entire subscriber-side processing apparatus 101.

The magnetic disk device 303 stores the various types of processing programs or data. The input device 304 performs various types of inputs for displaying the advertisement contents stored in the advertiser-dedicated page data 209

The output device 305 performs various types of outputs accompanied with display of the advertisement contents. CD-ROM device 306 reads the contents of a CD-ROM recording the various types of processing programs. The communications device 307 executes communications with other processing apparatuses via network such as the Internet or an intranet.

Also, the subscriber-side processing apparatus 101 includes an advertisement contents request processing section 311 and an advertisement contents output processing section 312.

The advertisement contents request processing section 311 sends, from the subscriber-side processing apparatus 101 to the advertisement service/management processing apparatus 100, the sending request for the advertisement contents stored in the advertiser-dedicated page data 209 in the advertisement service/management processing apparatus 100. The advertisement contents output processing section 312 receives the advertisement contents sent from the advertisement service/management processing apparatus 100, and outputs the advertisement contents to the output device 305 of the subscriber-side processing apparatus 101.

A program for causing the subscriber-side processing apparatus 101 to function as the advertisement contents request processing section 311 and the advertisement contents output processing section 312 is recorded into a recording medium such as a CD-ROM and is stored into the magnetic disk or the like. After that, the above-described program is loaded onto the memory, then being executed. Incidentally, the recording medium for recording the program may be another recording medium other than the CD-ROM.

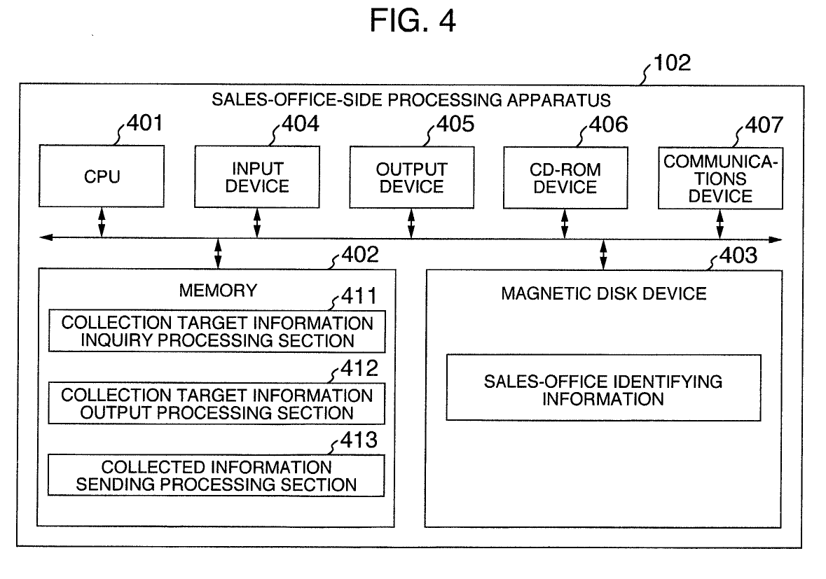

FIG. 4 is a diagram for illustrating schematic configuration of the sales-office-side processing apparatus 102 in the present embodiment. As illustrated in FIG. 4, the sales-office-side processing apparatus 102 in the present embodiment includes a CPU 401, a memory 402, a magnetic disk device 403, an input device 404, an output device 405, a CD-ROM device 406, and a communications device 407.

CPU 401 controls operation of the entire sales-office-side processing apparatus 102. The memory 402 loads various types of processing programs or data for control, when controlling operation of the entire sales-office-side processing apparatus 102.

The magnetic disk device 403 stores the various types of processing programs or data. The input device 404 performs various types of inputs for supporting collection of the advertisement usage fee. The output device 405 performs various types of outputs accompanied with the collection support of the advertisement usage fee.

The CD-ROM device 406 reads the contents of a CD-ROM recording the various types of processing programs. The communications device 407 executes communications with other processing apparatuses via network such as the Internet or an intranet.

Also, the sales-office-side processing apparatus 102 includes a collection target information inquiry processing section 411, a collection target information output processing section 412, and a collected information sending processing section 413.

The collection target information inquiry processing section 411 sends, from the sales-office-side processing apparatus 102 to the advertisement service/management processing apparatus 100, an inquiry about the collection target information indicating an advertiser as a collection target of the advertisement usage fee. The collection target information output processing section 412 receives the collection target information from the advertisement service/management processing apparatus 100, and outputs the collection target information to the output device 405 of the sales-office-side processing apparatus 102. The collected information sending processing section 413 sends, from the sales-office-side processing apparatus 102 to the advertisement service/management processing apparatus 100, the collected information indicating the advertiser to which the collection of the advertisement usage fee has been made.

A program for causing the sales-office-side processing apparatus 102 to function as the collection target information inquiry processing section 411, the collection target information output processing section 412, and the collected information sending processing section 413 is recorded into a recording medium such as a CD-ROM and is stored into the magnetic disk or the like. After that, the above-described program is loaded onto the memory, then being executed. Incidentally, the recording medium for recording the program may be another recording medium other than the CD-ROM.

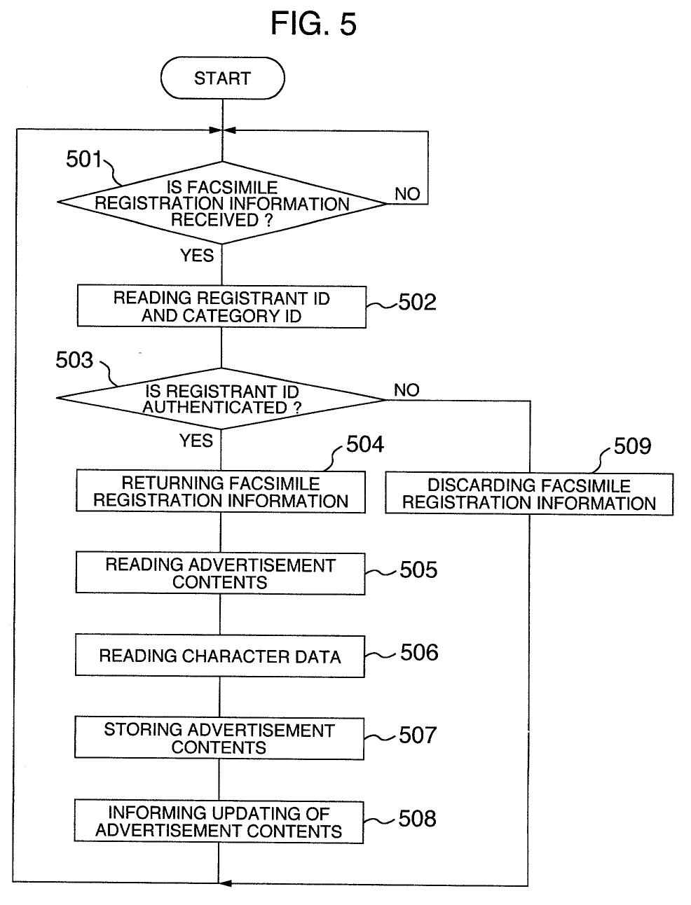

FIG. 5 is a flowchart for illustrating processing steps of the advertisement registration processing in the present embodiment. As illustrated in FIG. 5, the advertisement registration processing section 211 in the advertisement service/management processing apparatus 100 receives, from the facsimile apparatus 103 of the advertiser, facsimile registration information indicating the registrant ID for identifying the advertiser, the category ID, and the advertisement contents, and stores the image data into the advertiser-dedicated page data 209 stored in the advertisement service/management processing apparatus 100, the advertiser-dedicated page data 209 corresponding to the registrant ID and the category ID described in the facsimile registration information.

In the advertisement contents providing system in the present embodiment, when issuing such information as the execution of a time service depending on a selling situation at a supermarket on the day, the advertiser fills in a facsimile registration sheet with the registrant ID for identifying the advertiser, the category ID, and the advertisement contents. Then, the advertiser sends the facsimile registration sheet from the facsimile apparatus 103 of the advertiser to the advertisement service/management processing apparatus 100.

At step 501, the advertisement registration processing section 211 in the advertisement service/management processing apparatus 100 checks whether or not the facsimile registration information indicating the registrant ID, the category ID, and the advertisement contents has been received by the communications device 207 from the facsimile apparatus 103 of the advertiser. If the facsimile registration information has been received, the advertisement registration processing goes to step 502.

At step 502, the processing recognizes and reads the registrant ID and the category ID in the facsimile registration information received. At step 503, the processing checks whether or not the read registrant ID coincides with the registrant ID recorded in the advertiser information database 208. If the read registrant ID coincides therewith, the processing goes to step 504.

At step 504, the processing reads, from the advertiser information database 208, the facsimile number of the advertiser identified by the registrant ID. Then, the processing sends the facsimile registration information back to the facsimile apparatus 103 that is addressed to the facsimile number, thereby informing the advertiser that the advertisement contents of the advertiser will be modified in accordance with the facsimile registration information. In this way, in the present embodiment, the facsimile registration information is sent back, thereby informing the advertiser that the modification of the advertisement contents will be performed. Consequently, if there exists a mistake about the facsimile registration information, or if a third person other than the advertiser has sent the facsimile registration information, it is possible to let the advertiser know the facts.

At step 505, the processing recognizes an area for identifying the advertisement contents in the received facsimile registration information, and extracts image data existing within the area, then generates a HTML file for displaying the image data. At step 506, the processing recognizes characters in the extracted image data so as to extract the character data, then generates an HTML file for displaying the character data.

At step 507, the processing makes access to a directory corresponding to the registrant ID and the category ID recognized at step 502. Next, the processing stores, as the advertiser-dedicated page data 209 within the directory, the image data extracted at step 505 and the HTML file generated at the same step, and the character data extracted at step 506 and the HTML file generated at the same step.

At step 508, the processing generates a mail message storing the character data extracted at step 506, and sends an electronic mail to a subscriber of the advertisement contents, thereby informing the subscriber that the updating of the advertisement contents has been performed. Also, as the result of having checked, at step 503, whether or not the registrant ID read at step 502 coincides with the registrant ID recorded in the advertiser information database 208, if the read registrant ID does not coincide therewith, the processing goes to step 509 so as to discard the facsimile registration information.

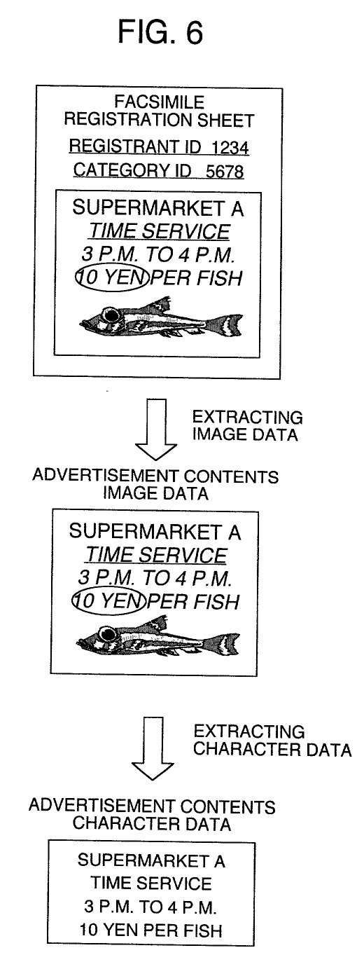

FIG. 6 is a diagram for illustrating one example of the advertisement contents in the present embodiment. As illustrated in FIG. 6, in the present embodiment, after extracting from the received facsimile registration information the image data indicating the advertisement contents, the unit recognizes the characters in the image data so as to extract the character data. The image data is used for displaying the advertisement contents at an information processing apparatus with a wide display screen such as a desktop-type information processing apparatus. Also, the character data is used for displaying the advertisement contents at an information processing apparatus with a small display screen such as a portable cellular phone, or is used for an electronic mail.

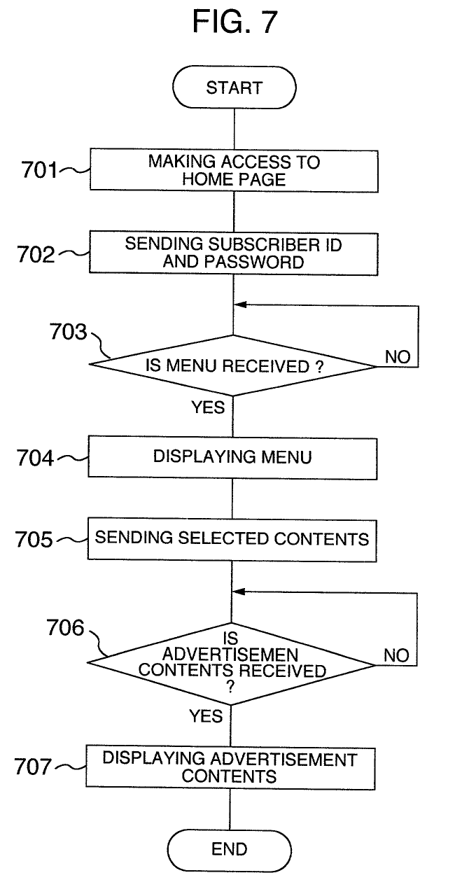

FIG. 7 is a flowchart for illustrating the processing steps of the advertisement contents display processing in the present embodiment. As illustrated in FIG. 7, the advertisement contents request processing section 311 in the subscriber-side processing apparatus 101 sends, from the subscriber-side processing apparatus 101 to the advertisement service/management processing apparatus 100, a sending request for the advertisement contents stored in the advertiser-dedicated page data 209. The advertisement contents output processing section 312 executes the processing of receiving the advertisement contents sent from the advertisement service/management processing apparatus 100, and outputs the advertisement contents to the output device 305 of the subscriber-side processing apparatus 101.

At step 701, the advertisement contents request processing section 311 in the subscriber-side processing apparatus 101 makes access via network to a home page of the newspaper sales-office set up in the advertisement service/management processing apparatus 100, and receives, from the advertisement service/management processing apparatus 100, a log-in page for viewing the advertisement contents on the home page of the newspaper sales-office, then displays the log-in page onto the output device 305. At step 702, the advertisement contents request processing section receives the input of a subscriber ID and a subscriber password from the subscriber, sends the subscriber ID and the password to the advertisement service/management processing apparatus 100.

At step 703, the processing checks whether or not a menu page for selecting the category of the advertisement contents published on the home page of the newspaper sales-office has been received from the advertisement service/management processing apparatus 100. If the menu page has been received, the processing goes to step 704.

At step 704, the processing displays, onto the output device 305, the contents of the menu page received from the advertisement service/management processing apparatus 100. At step 705, the processing receives from the subscriber the selection for the menu, then sends, to the advertisement service/management processing apparatus 100, the selected contents together with processing apparatus identifying information indicating whether or not the subscriber-side processing apparatus 101 is a portable-type information processing apparatus such as a portable cellular phone.

At step 706, the advertisement contents output processing processing 312 checks whether or not an HTML file indicating the advertisement contents by the image data or an HTML file indicating the advertisement contents by the character data alone has been received from the advertisement service/management processing apparatus 100. If the advertisement contents have been received, the advertisement contents output processing goes to step 707.

At step 707, the processing outputs, to the output device 305 of the subscriber-side processing apparatus 101, the HTML file indicating the advertisement contents by the image data or the HTML file indicating the advertisement contents by the character data alone.

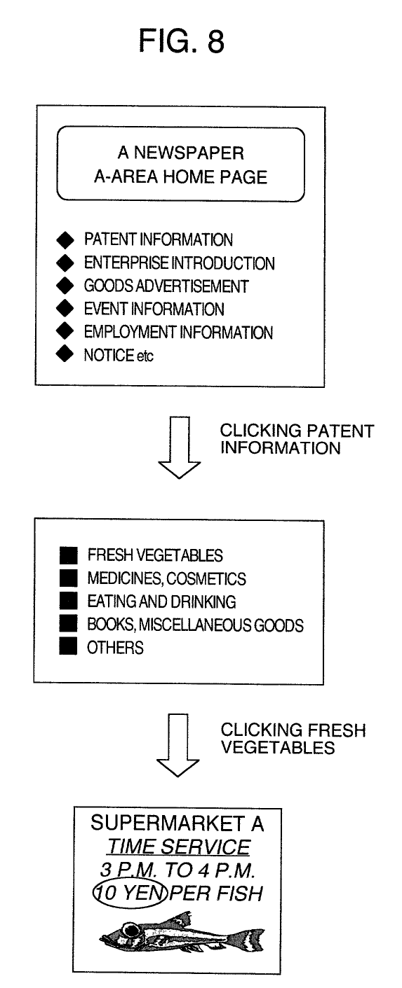

FIG. 8 is a diagram for illustrating one example of the menu display in the present embodiment. As illustrated in FIG. 8, the advertisement contents of a category such as fresh vegetables is stored as the advertiser-dedicated page data 209 on the home page of the A area newspaper sales-office. Selecting the respective menu items allows the subscriber to view the advertisement contents.

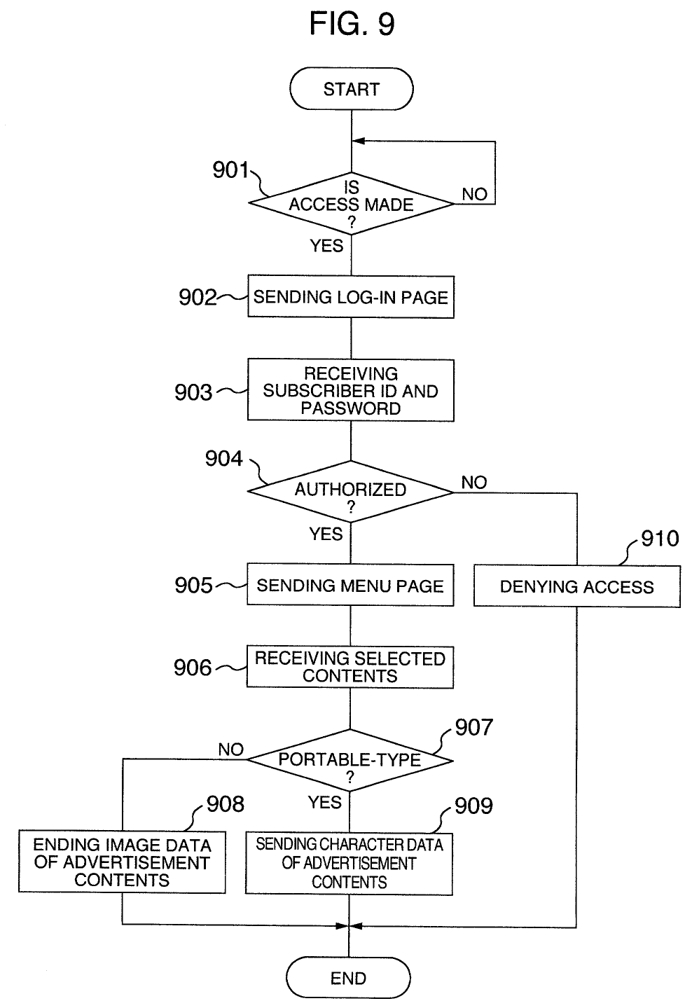

FIG. 9 is a flowchart for illustrating the processing steps of the advertisement contents sending processing in the present embodiment. As illustrated in FIG. 9, the advertisement contents sending processing section 212 in the advertisement service/management processing apparatus 100 reads, from the advertiser-dedicated page data 209, the advertisement contents requested from the subscriber-side processing apparatus 101, and sends the advertisement contents to the subscriber-side processing apparatus 101 of the request source.

At step 901, the advertisement contents sending processing section 212 in the advertisement service/management processing apparatus 100 checks whether or not an access from the subscriber-side processing apparatus 101 has been made via the network to the home page of the newspaper sales-office set up in the advertisement service/management processing apparatus 100. If the access from the subscriber-side processing apparatus 101 has been made, the advertisement contents sending processing processing goes to step 902.

At step 902, the processing sends, to the subscriber-side processing apparatus 101, the log-in page for viewing the advertisement contents on the home page of the newspaper sales-office. At step 903, the processing receives the subscriber ID and the password sent from the subscriber-side processing apparatus 101, and goes to step 904. At step 904, the processing performs authentication processing of ascertaining whether or not the subscriber ID and the password are authorized ones. If the subscriber ID and the password are authorized ones, the processing goes to a step 905.

At step 905, the processing sends, to the subscriber-side processing apparatus 101, the menu page for selecting the category of the advertisement contents published on the home page of the newspaper sales-office. At step 906, the processing receives, from the subscriber-side processing apparatus 101, the selected contents of the menu and the processing apparatus identifying information indicating whether or not the subscriber-side processing apparatus 101 is the portable-type information processing apparatus.

At step 907, making reference to the contents of the processing apparatus identifying information received, the processing checks whether or not the subscriber-side processing apparatus 101 that has sent the selected contents of the menu is the portable-type information processing apparatus. If the subscriber-side processing apparatus 101 is not the portable-type information processing apparatus, the processing goes to step 908. Also, if the subscriber-side processing apparatus 101 is the portable-type information processing apparatus, the processing goes to step 909.

At step 908, the processing makes access to the directory corresponding to the selected contents of the menu, then sends the subscriber-side processing apparatus 101 the image data extracted at step 505 in FIG. 5 and the HTML file generated at the same step. Also, at step 909, the processing makes access to the directory corresponding to the selected contents of the menu, then sends the subscriber-side processing apparatus 101 the character data extracted at step 506 and the HTML file generated at the same step.

Also, as the result of having performed, at step 904, the authentication processing of ascertaining whether or not the subscriber ID and the password received at step 903 are authorized ones, if the subscriber ID and the password are not authorized ones, the processing goes to step 910 so as to send the subscriber-side processing apparatus 101 a page of denying the access.

In the present embodiment, when the sales-office performs the collection of the advertisement charge of the advertisement provided by the advertisement service/management processing apparatus 100, processing is performed which supports the collection of the advertisement usage fee.

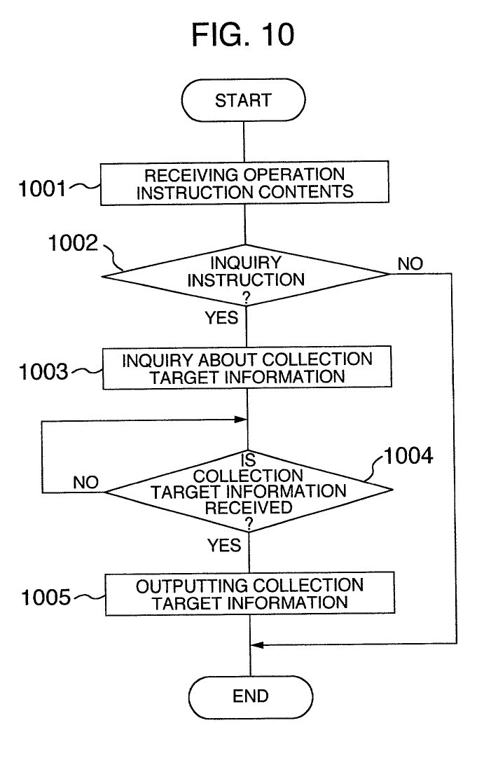

FIG. 10 is a flowchart for illustrating the processing steps of the collection target information inquiry processing in the present embodiment. As illustrated in FIG. 10, the collection target information inquiry processing section 411 in the sales-office-side processing apparatus 102 sends, from the sales-office-side processing apparatus 102 to the advertisement service/management processing apparatus 100, the inquiry about the collection target information indicating the advertiser as the collection target of the advertisement usage fee. The collection target information output processing section 412 receives the collection target information from the advertisement service/management processing apparatus 100, and outputs the collection target information to the output device 405 of the sales-office-side processing apparatus 102.

At a step 1001, the collection target information inquiry processing section 411 in the sales-office-side processing apparatus 102 receives the input of operation instruction contents from a user who operates the sales-office-side processing apparatus 102. At step 1002, the collection target information inquiry processing checks whether there has been performed or not the inquiry instruction about the collection target information indicating the advertiser as the collection target of the advertisement usage fee. If the inquiry instruction has been performed, the processing goes to step 1003.

At step 1003, the processing sends, from the sales-office-side processing apparatus 102 to the advertisement service/management processing apparatus 100, the inquiry about the collection target information together with sales-office identifying information for identifying the sales-office.

At step 1004, the collection target information output processing section 412 checks whether or not the collection target information has been received from the advertisement service/management processing apparatus 100. If the collection target information has been received, the collection target information output processing section goes to step 1005.

At step 1005, the processing makes reference to the collection target information received from the advertisement service/management processing apparatus 100, then outputs to the output device 405 of the sales-office-side processing apparatus 102 the information on the advertiser as the collection target of the advertisement usage fee.

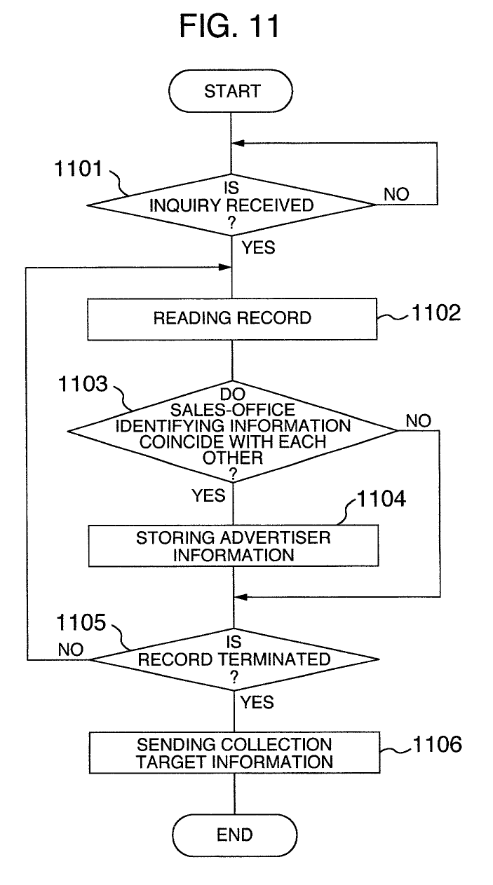

FIG. 11 is a flowchart for illustrating the processing steps of the collection target information sending processing in the present embodiment. As illustrated in FIG. 11, the collection target information sending processing section 213 in the advertisement service/management processing apparatus 100 receives, from the sales-office-side processing apparatus 102 set in the sales-office, the inquiry about the collection target information indicating the advertiser as the collection target of the advertisement usage fee, makes reference to the advertiser information in the advertiser information database 208, and reads, of the advertisers indicated by the advertiser information, information on an advertiser in charge of the sales-office that has made the above-described inquiry, and sends, to the sales-office-side processing apparatus 102, the information on the read advertiser as the collection target information indicating the advertiser to which the sales-office will make the collection of the advertisement usage fee.

At step 1101, the collection target information sending processing section 213 in the advertisement service/management processing apparatus 100 checks whether the inquiry about the collection target information indicating the advertiser as the collection target of the advertisement usage fee and the sales-office identifying information for identifying the sales-office have been received from the sales-office-side processing apparatus 102 or not. If the inquiry about the collection target information has been received, the collection target information sending processing goes to step 1102.

At step 1102, the processing reads an advertiser information record in the advertiser information database 208. At step 1103, the processing checks whether or not sales-office identifying information recorded in the read advertiser information record coincides with the sales-office identifying information received at step 1101. If the sales-office identifying information coincides with each other, the processing goes to step 1104. At step 1104, the processing stores the advertiser information in the advertiser information record into the memory 202 as the collection target information, and then goes to a step 1105.

At step 1105, the processing checks whether or not the advertiser information record in the advertiser information database 208 has been terminated. If the advertiser information record has been terminated, the processing goes to step 1106. If the advertiser information record has been not terminated yet, the processing returns back to step 1102. At step 1106, the processing sends the sales-office-side processing apparatus 102 the collection target information stored in the memory 202.

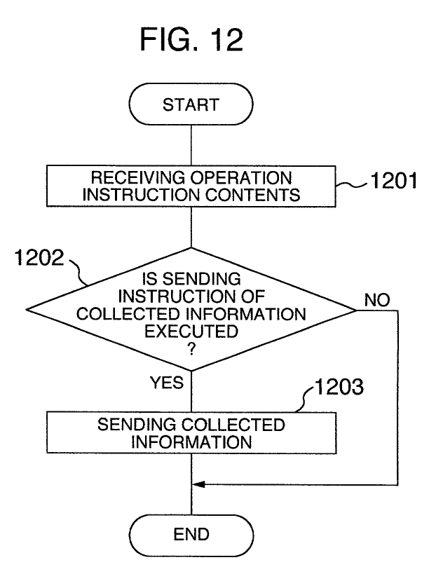

FIG. 12 is a flowchart for illustrating the processing steps of the collected information sending processing in the present embodiment. As illustrated in FIG. 12, the collected information sending processing section 413 in the sales-office-side processing apparatus 102 sends, from the sales-office-side processing apparatus 102 to the advertisement service/management processing apparatus 100, the collected information indicating the advertiser to which the collection of the advertisement usage fee has been made.

At step 1201, the collected information sending processing section 413 in the sales-office-side processing apparatus 102 receives the input of the operation instruction contents from the user who operates the sales-office-side processing apparatus 102. At step 1202, the collected information sending processing checks whether there has been performed or not a sending instruction of the collected information indicating the advertiser to which the collection of the advertisement usage fee has been made. If the sending instruction of the collected information has been performed, the processing goes to step 1203. At step 1203, the processing sends, from the sales-office-side processing apparatus 102 to the advertisement service/management processing apparatus 100, the collected information together with the sales-office identifying information for identifying the sales-office.

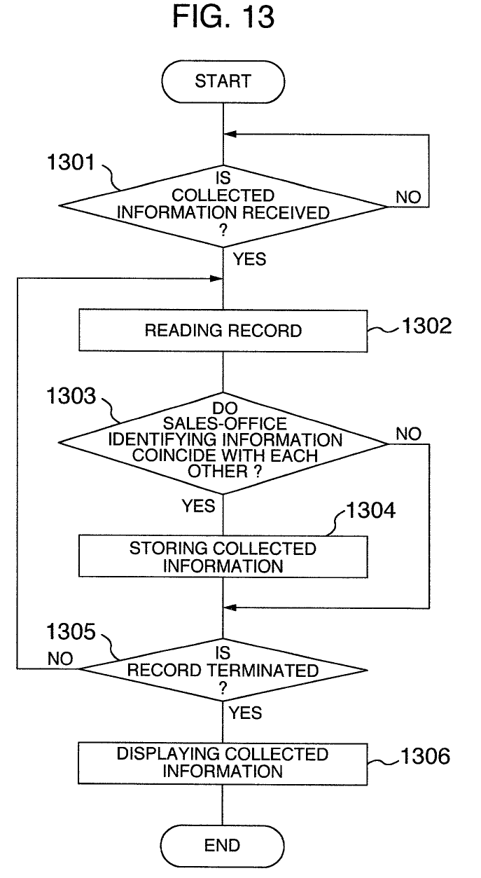

FIG. 13 is a flowchart for illustrating the processing steps of the collected information output processing in the present embodiment. As illustrated in FIG. 13, the collected information output processing section 214 in the advertisement service/management processing apparatus 100 receives, from the sales-office-side processing apparatus 102, the collected information indicating the advertiser to which the collection of the advertisement usage fee has been made, and outputs the collected information to the output device 205 of the advertisement service/management processing apparatus 100.

At step 1301, the collected information output processing section 214 in the advertisement service/management processing apparatus 100 checks whether the collected information indicating the advertiser to which the collection of the advertisement usage fee has been made and the sales-office identifying information for identifying the sales-office have been received or not from the sales-office-side processing apparatus 102. If the collected information has been received, the collected information output processing goes to step 1302.

At step 1302, the processing reads the advertiser information record in the advertiser information database 208. At step 1303, the processing checks whether or not the sales-office identifying information recorded in the read advertiser information record coincides with the sales-office identifying information received at step 1301. If the sales-office identifying information coincides with each other, the processing goes to step 1304. At step 1304, the processing stores, into the advertiser information record, the collected information indicating that the collection of the advertisement usage fee that month has been made, and then goes to step 1305.

At step 1305, the processing checks whether or not the advertiser information record in the advertiser information database 208 has been terminated. If the advertiser information record has been terminated, the processing goes to step 1306. If the advertiser information record has been not terminated yet, the processing returns back to step 1302.

At step 1306, the processing displays the collected information onto the output device 205 of the advertisement service/management processing apparatus 100, thereby informing the user of the advertisement service/management processing apparatus 100 that the collected information has been stored into the advertiser information database 208.

As having been explained so far, according to the advertisement contents providing system in the present embodiment, the advertisement contents sent from the facsimile apparatus of the advertiser is stored into the advertiser-dedicated page data, then outputted to the output device of the subscriber-side processing apparatus. This condition permits the information to be delivered immediately and easily on the information processing apparatus connected to network, without intervention of complicated operation of the information processing apparatus.

According to the present invention, the advertisement contents sent from the facsimile apparatus of the advertiser is stored into the advertiser-dedicated page data, then outputted to the output device of the subscriber-side processing apparatus. This condition permits the information to be delivered immediately and easily on the information processing apparatus connected to network, without intervention of complicated operation of the information processing apparatus.

1. An advertisement contents providing method of displaying, on an information processing apparatus connected to a network, advertisement contents registration of which has been requested from a facsimile apparatus, comprising the steps of:
receiving facsimile registration information from said facsimile apparatus of an advertiser, said facsimile registration information indicating a registrant ID, a category ID, and said advertisement contents, and, of advertiser-dedicated page data in an advertisement service/management processing apparatus, storing image data of said advertisement contents into advertiser-dedicated page data corresponding to said registrant ID and said category ID described in said facsimile registration information,
sending a sending request for said advertisement contents from a subscriber-side processing apparatus to said advertisement service/management processing apparatus, said advertisement contents being stored in said advertiser-dedicated page data in said advertisement service/management processing apparatus,
reading said advertisement contents from said advertiser-dedicated page data in said advertisement service/management processing apparatus, said advertisement contents being requested from said subscriber-side processing apparatus, and sending said advertisement contents to said subscriber-side processing apparatus which is a request source, and
receiving said advertisement contents sent from said advertisement service/management processing apparatus and outputting said advertisement contents to an output device of said subscriber-side processing apparatus.

2. The advertisement contents providing method as claimed in claim 1, wherein, when said facsimile registration information is received, said facsimile registration information is sent back to said facsimile apparatus of said advertiser identified by said registrant ID in said facsimile registration information.

3. The advertisement contents providing method as claimed in claim 1, wherein characters in said image data of said advertisement contents are recognized so as to generate advertiser-dedicated page data consisting of character data, and when said subscriber-side processing apparatus that has sent said sending request for said advertisement contents is a portable-type information processing apparatus, said generated advertiser-dedicated page data consisting of said character data is sent to said subscriber-side processing apparatus which is said request source.

4. The advertisement contents providing method as claimed in claim 2, wherein characters in said image data of said advertisement contents are recognized so as to generate advertiser-dedicated page data consisting of character data, and when said subscriber-side processing apparatus that has sent said sending request for said advertisement contents is a portable-type information processing apparatus, said generated advertiser-dedicated page data consisting of said character data is sent to said subscriber-side processing apparatus which is said request source.

5. The advertisement contents providing method as claimed in claim 1, further comprising the steps of:
sending an inquiry about collection target information from a sales-office-side processing apparatus to said advertisement service/management processing apparatus, said collection target information indicating an advertiser as a collection target of an advertisement usage fee,
receiving said inquiry from said sales-office-side processing apparatus, and making reference to advertiser information indicating information on advertisers that have made said contract to perform advertisement publication on said advertiser-dedicated page in said advertisement service/management processing apparatus, and reading, of said advertisers indicated by said advertiser information, information on an advertiser that is in charge of a sales-office that has made said inquiry, and sending, to said sales-office-side processing apparatus, said read information on said advertiser as said collection target information indicating said advertiser to which said sales-office will perform said collection of said advertisement usage fee,
receiving said collection target information from said advertisement service/management processing apparatus, and outputting said collection target information to an output device of said sales-office-side processing apparatus,
sending collected information from said sales-office-side processing apparatus to said advertisement service/management processing apparatus, said collected information indicating said advertiser to which said collection of said advertisement usage fee has been performed, and
receiving said collected information from said sales-office-side processing apparatus, and outputting said collected information to an output device of said advertisement service/management processing apparatus.

6. The advertisement contents providing method as claimed in claim 2, further comprising the steps of:
sending an inquiry about collection target information from a sales-office-side processing apparatus to said advertisement service/management processing apparatus, said collection target information indicating an advertiser as a collection target of an advertisement usage fee,
receiving said inquiry from said sales-office-side processing apparatus, and making reference to advertiser information indicating information on advertisers that have made said contract to perform said advertisement publication on said advertiser-dedicated page in said advertisement service/management processing apparatus, and reading, of said advertisers indicated by said advertiser information, information on an advertiser that is in charge of a sales-office that has made said inquiry, and sending, to said sales-office-side processing apparatus, said read information on said advertiser as said collection target information indicating said advertiser to which said sales-office will perform said collection of said advertisement usage fee,
receiving said collection target information from said advertisement service/management processing apparatus, and outputting said collection target information to an output device of said sales-office-side processing apparatus,
sending collected information from said sales-office-side processing apparatus to said advertisement service/management processing apparatus, said collected information indicating said advertiser to which said collection of said advertisement usage fee has been performed, and
receiving said collected information from said sales-office-side processing apparatus, and outputting said collected information to an output device of said advertisement service/management processing apparatus.

7. An advertisement contents providing system for displaying, on an information processing apparatus connected to a network, advertiser registration of which has been requested from a facsimile apparatus, comprising:
an advertisement registration processing section for receiving facsimile registration information from said facsimile apparatus of an advertiser, said facsimile registration information indicating a registrant ID, a category ID, and said advertisement contents, and, of advertiser-dedicated page data in an advertisement service/management processing apparatus, storing image data of said advertisement contents into advertiser-dedicated page data corresponding to said registrant ID and said category ID described in said facsimile registration information,
an advertisement contents request processing section for sending a sending request for said advertisement contents from a subscriber-side processing apparatus to said advertisement service/management processing apparatus, said advertisement contents being stored in said advertiser-dedicated page data in said advertisement service/management processing apparatus,
an advertisement contents sending processing section for reading said advertisement contents from said advertiser-dedicated page data in said advertisement service/management processing apparatus, said advertisement contents being requested from said subscriber-side processing apparatus, and sending said advertisement contents to said subscriber-side processing apparatus which is a request source, and
an advertisement contents output processing section for receiving said advertisement contents sent from said advertisement service/management processing apparatus and outputting said advertisement contents to an output device of said subscriber-side processing apparatus.

8. An advertisement service/management processing apparatus for displaying, on an information processing apparatus connected to a network, advertisement contents registration of which has been requested from a facsimile apparatus, comprising:
an advertisement registration processing section for receiving facsimile registration information from said facsimile apparatus of an advertiser, said facsimile registration information indicating a registrant ID, a category ID, and said advertisement contents, and, of advertiser-dedicated page data in said advertisement service/management processing apparatus, storing image data of said advertisement contents into advertiser-dedicated page data corresponding to said registrant ID and said category ID described in said facsimile registration information, and
an advertisement contents sending processing unit for reading said advertisement contents from said advertiser-dedicated page data in said advertisement service/management processing apparatus, said advertisement contents being requested from a subscriber-side processing apparatus, and sending said advertisement contents to said subscriber-side processing apparatus which is a request source.

9. The advertisement service/management processing apparatus as claimed in claim 8, further comprising:
a collection target information sending processing section for receiving an inquiry about collection target information from a sales-office-side processing apparatus set at a sales-office, said collection target information indicating an advertiser as a collection target of an advertisement usage fee, and making reference to advertiser information indicating information on advertisers that have made said contract to perform said advertisement publication on said advertiser-dedicated page in said advertisement service/management processing apparatus, and reading, of said advertisers indicated by said advertiser information, information on an advertiser that is in charge of said sales-office that has made said inquiry, and sending, to said sales-office-side processing apparatus, said read information on said advertiser as said collection target information indicating said advertiser to which said sales-office will perform said collection of said advertisement usage fee, and
a collected information output processing section for receiving collected information from said sales-office-side processing apparatus, said collected information indicating said advertiser to which said collection of said advertisement usage fee has been performed, and outputting said collected information to an output device of said advertisement service/management processing apparatus.

10. A subscriber-side processing apparatus for displaying, on an information processing apparatus connected to a network, advertisement contents registration of which has been requested from a facsimile apparatus, comprising:
an advertisement contents request processing section for sending a sending request for said advertisement contents from said subscriber-side processing apparatus to an advertisement service/management processing apparatus, said advertisement contents being stored in advertiser-dedicated page data in said advertisement service/management processing apparatus, and
an advertisement contents output processing section for receiving said advertisement contents sent from said advertisement service/management processing apparatus and outputting said advertisement contents to an output device of said subscriber-side processing apparatus.

11. A sales-office-side processing apparatus for supporting a collection of an advertisement usage fee when displaying, on an information processing apparatus connected to a network, advertisement contents registration of which has been requested from a facsimile apparatus, comprising:
a collection target information inquiry processing section for sending an inquiry about collection target information from said sales-office-side processing apparatus to an advertisement service/management processing apparatus, said collection target information indicating an advertiser as a collection target of said advertisement usage fee,
a collection target information output processing section for receiving said collection target information from said advertisement service/management processing apparatus and outputting said collection target information to an output device of said sales-office-side processing apparatus, and
a collected information sending processing section for sending a collected information from said sales-office-side processing apparatus to said advertisement service/management processing apparatus, said collected information indicating said advertiser to which said collection of said advertisement usage fee has been performed.

12. A computer-readable recording medium that has recorded a program for causing a computer to function as an advertisement service/management processing apparatus for displaying, on an information processing apparatus connected to a network, advertisement contents registration of which has been requested from a facsimile apparatus, wherein said program for causing said computer to function as an advertisement registration processing section and an advertisement contents sending processing section is recorded,
said advertisement registration processing section receiving facsimile registration information from said facsimile apparatus of an advertiser, said facsimile registration information indicating a registrant ID, a category ID, and said advertisement contents, and, of advertiser-dedicated page data in said advertisement service/management processing apparatus, storing image data of said advertisement contents into advertiser-dedicated page data corresponding to said registrant ID and said category ID described in said facsimile registration information,
said advertisement contents sending processing section reading said advertisement contents from said advertiser-dedicated page data in said advertisement service/management processing apparatus, said advertisement contents being requested from a subscriber-side processing apparatus, and sending said advertisement contents to said subscriber-side processing apparatus which is a request source.
